(19) United States
(12) Patent Application Publication
(10) Pub. No.: US 2022/0027706 A1
(43) Pub. Date: Jan. 27, 2022

(54) Membrane Fouling Warning Method Based on Knowledge-Fuzzy Learning Algorithm

(71) Applicant: BEIJING UNIVERSITY OF TECHNOLOGY, BEIJING (CN)

(72) Inventors: Honggui HAN, BEIJING (CN); Zheng LIU, BEIJING (CN); Junfei QIAO, BEIJING (CN)

(21) Appl. No.: 17/382,237

(22) Filed: Jul. 21, 2021

(30) Foreign Application Priority Data
Jul. 22, 2020 (CN) 202010708584.3

(51) Int. Cl. G06N 3/04; G06N 7/02; G06F 17/18

(52) U.S. Cl. CPC G06N 3/0436; G06N 7/023; G06F 17/18; C02F 3/1268; C02F 2209/42; C02F 2209/03; C02F 2209/11; C02F 2303/20

(57) ABSTRACT

An intelligent warning method based on knowledge-fuzzy learning algorithm is designed for membrane fouling with high accuracy. A multi-step prediction strategy, using the least-squares linear regression model, is developed to predict the characteristic variables of membrane fouling Meanwhile, the knowledge of membrane fouling category, which is extracted from the real wastewater treatment process, can be expressed as the form of fuzzy rules. Moreover, a knowledge-based fuzzy neural network is designed to establish the membrane fouling warning model, thus deal with the problem of difficult warning of membrane fouling. The results reveal that the intelligent warning method can improve the ability to solve the membrane fouling, mitigate the deleterious effect on the process performance and ensure the safety operation of the wastewater treatment process.

### CROSS-REFERENCE TO RELATED APPLICATION

This application claims priority to Chinese Patent Application No. 202010708584.3, filed on Jul. 22, 2020, which is hereby incorporated by reference in its entirety.

### Technology Area

In this patent, an intelligent warning method is designed for the membrane fouling in the sewage treatment process of membrane bioreactor. To improve the warning accuracy, a multi-step prediction strategy is developed to predict the characteristic variables of membrane fouling and a knowledge-based fuzzy neural network is designed to realize intelligent warning of membrane fouling. The technology of this patent is part of advanced manufacturing technology, belongs to both the field of control engineer and environment engineer. Therefore, membrane fouling intelligent warning in wastewater treatment process is of great significance.

### Technology Background

During the development in past decades, China is the world's top wastewater emitter, accounting for 350 million cubic meters. The daily urban wastewater treatment capacity has reached 15 percent. The Ministry of Housing and Urban-Rural Development, the Ministry of Ecology and Environment and the National Development and Reform Commission Development have proposed a three-year action plan from 2019 to 2021 to improve the quality and efficiency of the urban wastewater treatment, providing the guidelines for local government departments to take effective and practical technology. Membrane bioreactor is a new kind of wastewater treatment technology, which combines membrane separation technology and traditional sludge treatment technology. Meanwhile, membrane bioreactor has been considered as the most potential and competitive wastewater recycling technology in the twenty-first century.

The membrane bioreactor has been widely used to purify wastewater in wastewater treatment process. It has many advantages, such as good effluent quality, low sludge production, low land occupation and convenient operation. However, during the process of applying membrane bioreactor to wastewater treatment process, membrane fouling is unavoidable. Membrane fouling will result in the decrease of water production and has seriously affected the quality of effluent and operation performance. Moreover, the increase of cleaning frequency and replacement frequency of membrane components will lead to the additional energy consumption and cost, which have limited the development of membrane bioreactor. To reduce the membrane fouling, it is important to warn the category of membrane fouling. The warning can be put forward before the deterioration of water quality, which can provide the staff of the wastewater plant for taking corresponding actions. Thus, it is of great significance to achieve the early warning technology for membrane fouling.

The invention proposed an intelligent warning method for the membrane fouling in the sewage treatment process of membrane bioreactor. A multi-step prediction strategy based on the least-squares linear regression model is used to predict the characteristic variables of membrane fouling with high accuracy. Meanwhile, the knowledge base of membrane fouling, which is extracted from the expert experience, is constructed. Then, a knowledge-based fuzzy neural network is developed to achieve warning of membrane fouling. Moreover, the intelligent warning method also reduce the energy consumption, improve the effluent quality, and provide a fast and efficient suggestions to guarantee the safety and stable operation of wastewater treatment process.

### SUMMARY

An intelligent warning method is designed for the membrane fouling based on knowledge-fuzzy learning algorithm in this patent. Its characteristic lies in obtaining membrane fouling warning model through the analysis of the characteristic variables of membrane fouling. A multi-step prediction strategy, using the least-squares linear regression model, is developed to predict the characteristic variables of membrane fouling. Meanwhile, a knowledge-based fuzzy neural network is designed to establish the membrane fouling warning model, thus realize intelligent warning of membrane fouling.

This patent adopts the following technical scheme and implementation steps:

(1) Determine the characteristic variables of membrane fouling: For the sewage treatment process of membrane bioreactor, the sewage treatment process variables are analyzed and the characteristic variables of membrane fouling are selected, including water permeability (P), permeability decay (PD), water flow (WF), gas washing size (GWS), sludge concentration (SC), transmembrane pressure (TMP), water turbidity (WT) and permeability recovery rate (PR).

(2) Predict the characteristic variables of membrane fouling in multi-step: The characteristic variable is obtained by a multi-step prediction strategy based on the least-squares linear regression model. The values of a characteristic variable with the first four moments are used to predict the characteristic variable at the fifth moment. The estimation of a characteristic variable using the least-squares linear regression model can be expressed as

x_{d}(n+4)=a_{d0}+a_{d1}x_{d}(n)+a_{d2}x_{d}(n+1)+a_{d3}x_{d}(n+2)+a_{d4}x_{d}(n+3), (1)

where x_{d}(n+h) is the dth characteristic variable value, n=1, 2, . . . , N−4, N is the number of samples, d=1, 2, . . . , 8, h=0, 1, . . . , 4, x₁(n+h) is the P value, x₂(n+h) is the PD value, x₃(n+h) is the WF value, x₄(n+h) is the GWS value, x₅(n+h) is the SC value, x₆(n+h) is the TMP value, x₇(n+h) is the WT value, x₈(n+h) is the PR value, a_{d0}, a_{d1}, a_{d2}, a_{d3}, a_{d4} are the different regression coefficients of the dth characteristic variable. Meanwhile, the dth characteristic variable satisfies

$$\begin{matrix}{Q}_{d} = {\sum }_{n = 1}^{N} {( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) )}^{2} , & ( 2 ) \\ \{ \begin{matrix}\frac{\partial {Q}_{d}}{\partial {a}_{d 0}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) = 0 \\ \frac{\partial {Q}_{d}}{\partial {a}_{d 1}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n ) = 0 \\ ⋮ \\ \frac{\partial {Q}_{d}}{\partial {a}_{d 4}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n + 3 ) = 0\end{matrix} , & ( 3 )\end{matrix}$$

where Q_{d} is the sum of squared errors of the dth characteristic variable with N samples, a_{d0}, a_{d1}, a_{d2}, a_{d3}, a_{d4} are calculated by Eq. (3).

(3) Construct the knowledge base of membrane fouling: The knowledge of membrane fouling, which is extracted from expert experience, can be expressed as the form of fuzzy rules

Rule I: If the WF value is more than 460 m³/h, then the WF value has reached its peak.

Rule II: If the P value is less than 30 LMH/bar and the TMP value is less than −5 kPa, then the membrane is in a state of extreme contamination.

Rule III: If the GWS value is less than 2400 m³/h and the TMP value is less than −20 kPa, then the aeration rate is too low and the membrane is facing serious pollution threat.

Rule IV: If the WF value is less than 300 m³/h and the GWS value is more than 8000 m³/h, then the aeration rate is too high and the membrane silk will be damaged.

Rule V: If the WT value is more than 5 NTU, then the effluent quality has exceeded the standard.

Rule VI: If the P value is more than 90 LMH/bar and the TMP value is less than −40 kPa, then the TMP value is too high and the membrane is facing serious pollution threat.

Rule VII: If the SC value is more than 13000 mg/L, then the SC value is too high and the membrane is facing serious pollution threat.

Rule VIII: If the SC value is less than 6000 mg/L, then the effluent quality has exceeded the standard.

Rule IX: If the P value is less than 80 LMH/bar, the WF value is more than 300 m³/h and the GWS value is less than 4200 m³/h, then the aeration rate is too low and the membrane is facing serious pollution threat.

Rule X: If the WF value is more than 200 m³/h and the WT value is more than 4 NTU, then the effluent quality has exceeded the standard.

Rule XI: If the P value is less than 60 LMH/bar and the TMP value is less than −5 kPa, then the membrane has been seriously polluted.

Rule XII: If the PD value is more than 30 LMH/bar·h, then there is rapid abnormal membrane fouling.

Rule XIII: If the P value is less than 60 LMH/bar, the WF value is more than 200 m³/h and the GWS value is less than 5000 m³/h, then there is a tendency of sludge hardening inside membrane silk.

Rule XIV: If the WF value is less than 300 m³/h, the GWS value is less than 5000 m³/h and the SC value is more than 12000 mg/L, then the operating parameters of membrane tank are unreasonable.

Rule XV: If the WF value is less than 200 m³/h and the PR value is less than 90%, then the online chemical cleaning effect fails to meet the requirements.

Rule XVI: If the P value is more than 80 LMH/bar, the PD value is less than 30 LMH/bar·h, the GWS value is more than 5000 m³/h, the SC value is less than 13000 mg/L, the WT value is less than 4 NTU and the PR value is more than 90%, then there is no warning.

Rule XVII: If the P value is more than 80 LMH/bar, the PD value is less than 30 LMH/bar·h, the GWS value is less than 8000 m³/h, the SC value is less than 13000 mg/L, the WT value is less than 4 NTU and the PR value is more than 90%, then there is no warning.

Rule XVIII: If the P value is more than 80 LMH/bar, the PD value is less than 30 LMH/bar·h, the GWS value is more than 5000 m³/h, the SC value is more than 6000 mg/L, the WT value is less than 4 NTU and the PR value is more than 90%, then there is no warning.

Rule XIX: If the P value is more than 80 LMH/bar, the PD value is less than 30 LMH/bar·h, the GWS value is less than 8000 m³/h, the SC value is more than 6000 mg/L, the WT value is less than 4 NTU and the PR value is more than 90%, then there is no warning.

The above rules of membrane fouling categories can be concluded as

If x₁(n)∈L₁ₖ(n) and . . . x_{d}(n)∈L_{dk}(n) and . . . x₈(n)∈L₈ₖ(n), then yⱼ(n)=rⱼ(n), (4)

where k is the kth fuzzy rule, k=1, 2, . . . , 19, L_{dk}(n) is the linguistic term of the dth characteristic variable in the nth fuzzy rule, yⱼ(n) is the jth membrane fouling category, rⱼ(n) is the linguistic term of the jth membrane fouling category and is formulated as

$${r}_{j} ( n ) = {\sum }_{k = 1}^{19} {v}_{k} ( n ) {w}_{k j} ( n ) , \qquad ( 5 )$$

where wₖⱼ(n) is the weight between the kth fuzzy rule in the rule layer and the jth membrane fouling category in the output layer, vₖ(n) is the output of the rule layer

$$\begin{matrix}{v}_{k} ( n ) = {\prod }_{d = 1}^{8} {L}_{dk} ( n ) / {\sum }_{k = 1}^{19} ( {\prod }_{d = 1}^{8} {L}_{dk} ( n ) ) , & ( 6 ) \\ {L}_{dn} ( n ) = {e}^{- {( {x}_{d} ( n ) - {c}_{dk} ( n ) )}^{2} / 2 {{σ}_{dk} ( n )}^{2} ,} & ( 7 )\end{matrix}$$

where c_{dk}(n) and σ_{dk}(n) are the center and width of the dth membership function in the kth fuzzy rule

$$\begin{matrix}{c}_{d k} ( n ) = \frac{{A}_{d k} ( n ) + {B}_{d k} ( n )}{2} , & ( 8 ) \\ {σ}_{d k} ( n ) = max ( \frac{{A}_{d k} ( n ) - {c}_{d k} ( n )}{\sqrt{- 2 ln {L}_{d k} ( n )}} , \frac{{c}_{d k} ( n ) - {B}_{d k} ( n )}{\sqrt{- 2 ln {L}_{d k} ( n )}} ) , & ( 9 )\end{matrix}$$

where A_{dk}(n) and B_{dk}(n) are the upper and lower values of the dth membership function in the kth fuzzy rule.

(4) Establish an intelligent warning model for membrane fouling: The characteristic variables are the input variables of the intelligent warning model. The output variables are selected from the knowledge base of membrane fouling. Then an intelligent warning model based on fuzzy neural network (FNN) is established. The structure of FNN comprises four layers: input layer, membership function layer, rule layer and output layer. The network is 8-19-19-16, including 8 neurons in the input layer, 19 neurons in the membership function layer, 19 neurons in the rule layer and 16 neurons in the output layer. Connection weights between the input layer and the membership function layer are assigned to 1, the input of FNN is X(t)=[x₁(t), x₂(t), . . . , x_{N}(t)], xₙ(t)=[x₁ₙ(t), x₂ₙ(t), . . . , x₈ₙ(t)], t=1, 2, . . . , T, T is the number of iterations. The expectation output of neural network is expressed as Yₑ(t) and the actual output is expressed as Y(t). The four layers of FNN are described in detail as follows:

The Input Layer:

There are 8 neurons which represent the input variables in this layer. The output value of each neuron is

uᵢ(t)=xᵢ(t), i=1,2, . . . ,8, (10)

where uᵢ(t) is the ith output vector at the tth iteration and the input vector is xᵢ(t)=[x₁(t), x₂(t), . . . , x_{N}(t)].

The Membership Function Layer:

There are 19 neurons of the membership function layer. The outputs of the membership function neurons are

$${φ}_{k} ( t ) = {\prod }_{d = 1}^{8} {e}^{- {( {u}_{d} ( t ) - {c}_{d k} ( t ) )}^{2} / 2 {{σ}_{d k} ( t )}^{2}} , \qquad ( 11 )$$

where c_{dk}(t) denotes the center vector of the kth membership function neuron at the tth iteration, c_{dk}(t)=[c_{dk1}(t), c_{dk2}(t), . . . , c_{dkN}(t)]^{T}, and σ_{dk}(t) is the width vector of the kth membership function neuron at the tth iteration, σ_{dk}(t)=[σ_{dk1}(t), σ_{dk2}(t), . . . , σ_{dkN}(t)]^{T}.

The Rule Layer:

There are 19 neurons of the rule layer. The outputs are

$${v}_{k} ( t ) = {φ}_{k} ( t ) / {\sum }_{k = 1}^{19} {φ}_{k} ( t ) , \qquad ( 12 )$$

where vₖ(t) is the output vector of the kth rule neuron at the tth iteration, vₖ(t)=[vₖ₁(t), vₖ₂(t), . . . , v_{kN}(t)]^{T}.

The Output Layer:

This layer contains 16 neurons. The output values are

$${Y}_{j} ( t ) = {\sum }_{k = 1}^{19} {v}_{k} ( t ) {w}_{kj} ( t ) , j = 1 , 2 , … , 16 , \qquad ( 13 )$$

where Yⱼ(t)=[y₁(t), y₂(t), . . . , y_{N}(t)], which is the membrane fouling category, represents the output of FNN at the tth iteration, wₖⱼ(t)=[wₖⱼ₁(t), wₖⱼ₂(t), . . . , w_{kjN}(t)]^{T} is the connection weight between the kth rule neuron and the jth output neuron at the tth iteration. Based on the softmax function, the probabilities of the output neurons are

$${p}_{j} ( t ) = \frac{{e}^{{Y}_{j} ( t )}}{{\sum }_{j = 1}^{16} {e}^{{Y}_{j} ( t )}} , \qquad ( 14 )$$

where pⱼ(t) is the probability vector of the jth output neuron at the tth iteration, pⱼ(t)=[pⱼ₁(t), pⱼ₂(t), . . . , p_{jN}(t)]^{T}, the jth membrane fouling category with the corresponding maximum value of pⱼ(t) is selected to warn the future events of membrane fouling.

(5) Train the FNN model:

\textcircled{1} Given the FNN model, the inputs of FNN are x(1), x(2), . . . , x(t), . . . , x(T), correspondingly, the expectation outputs are Y_{d}(1), Y_{d}(2), . . . , Y_{d}(t), . . . , Y_{d}(T). \textcircled{2} Set the learning step s=1. \textcircled{2} t=s; According to Eqs. (1)-(14), calculate the probabilities of the output neurons, exploiting gradient descent algorithm

$${w}_{kj} ( t + 1 ) = {w}_{kj} ( t ) + {η}_{w} \frac{1}{16} {\sum }_{j = 1}^{16} \{ {v}_{k} ( t ) [ Ι ( t ) - {p}_{j} ( t ) ] \} , \qquad ( 15 )$$

where wₖⱼ(t+1) is the connection weight between the kth rule neuron and the jth output neuron at the t+1th iteration, η_{w}∈(0, 0.01] is the learning rate, I(t)=[1{Y₁(t)}, 1{Y₂(t)}, . . . , 1{Y₁₆(t)}], 1{⋅} represents the indicator function.

\textcircled{4} If t≤T, go to step \textcircled{3}; if t>T, stop the training process.

(6) Realize membrane fouling warning:

The least-squares linear regression model utilizes the testing samples of P, PD, WF, GWS, SC, TMP, WT and PR to predict multiple values of these characteristic variables. Then, the testing samples of P, PD, WF, GWS, SC, TMP, WT and PR are used as the inputs of FNN, the outputs of FNN are the membrane fouling categories.

The Novelties of this Patent Contain:

(1) In order to realize the multiple membrane fouling, a multi-step prediction strategy is developed in this patent. The eight characteristic variables, which is related to the membrane fouling according to the work report of real-world membrane bioreactor, is extracted: P, PD, WF, GWS, SC, TMP, WT and PR. Then, a multi-step prediction strategy based on the least-squares linear regression model is developed to predict the characteristic variables of membrane fouling. The multi-step prediction strategy cannot only solve the problem that the characteristic variables of membrane fouling is hard to obtain the multiple values with acceptable accuracy, but also assist in the warning of membrane fouling.

(2) Based on a knowledge-based fuzzy neural network model, the invention can warn the membrane fouling through the classification of membrane fouling. The above model can not only make use of the knowledge from the expert experience to establish the waring model, but also identify the category of the membrane fouling to achieve the early warning that solve the difficult warning of membrane fouling in the membrane bioreactor. Then, the intelligent warning method will be in favor of the decision-maker in taking preventive and reactive measures to facilitate the effective and safe operation of membrane bioreactor.

Attention: the invention adopts the least-squares linear regression model and the knowledge-based fuzzy neural network to establish the warning method for membrane fouling in the membrane bioreactor. The research that adopts the least-squares linear regression model and the knowledge-based fuzzy neural network in this invention for intelligent warning of membrane fouling, should fall within the scope of the present invention.

### DESCRIPTION OF DRAWINGS

FIG. 1 shows the structure of intelligent warning method using the knowledge-based fuzzy neural network in this patent.

FIG. 2 shows the training result of the intelligent warning method.

FIG. 3 shows the testing result of the intelligent warning method.

### DETAILED DESCRIPTION OF THE INVENTION

This invention takes the characteristic variables P, PD, WF, GWS, SC, TMP, WT, PR. The unit of P is LMH/bar. The unit of PD is LMH/bar·h. The units of WF and GWS are m³/h. The unit of SC is mg/L. The unit of TMP is kPa. The unit of WT is NTU. The PR has no unit.

The experimental data comes from water quality analysis statement of a wastewater treatment plant in 2020; choosing data of P, PD, WF, GWS, SC, TMP, WT, PR as experimental samples, after eliminating abnormal sample, 100 groups of data are available, and the group of 60 used as training samples, the remaining 40 groups as test samples.

This patent adopts the following technical scheme and implementation steps.

An intelligent warning method is designed for the membrane fouling based on knowledge-fuzzy learning algorithm in this patent. Its characteristic lies in obtaining membrane fouling warning model through the analysis of the characteristic variables of membrane fouling. A multi-step prediction strategy, using the least-squares linear regression model, is developed to predict the characteristic variables of membrane fouling. Meanwhile, a knowledge-based fuzzy neural network is designed to establish the membrane fouling warning model, thus realize intelligent warning of membrane fouling.

This patent adopts the following technical scheme and implementation steps:

(1) Determine the characteristic variables of membrane fouling: For the sewage treatment process of membrane bioreactor, the sewage treatment process variables are analyzed and the characteristic variables of membrane fouling are selected, including water permeability (P), permeability decay (PD), water flow (WF), gas washing size (GWS), sludge concentration (SC), transmembrane pressure (TMP), water turbidity (WT) and permeability recovery rate (PR).

(2) Predict the characteristic variables of membrane fouling in multi-step: The characteristic variable is obtained by a multi-step prediction strategy based on the least-squares linear regression model. The values of a characteristic variable with the first four moments are used to predict the characteristic variable at the fifth moment. The estimation of a characteristic variable using the least-squares linear regression model can be expressed as

x_{d}(n+4)=a_{d0}+a_{d1}x_{d}(n)+a_{d2}x_{d}(n+1)+a_{d3}x_{d}(n+2)+a_{d4}x_{d}(n+3), (1)

where x_{d}(n+h) is the dth characteristic variable value, n=1, 2, . . . , N−4, N is the number of samples, d=1, 2, . . . , 8, h=0, 1, . . . , 4, x₁(n+h) is the P value, x₂(n+h) is the PD value, x₃(n+h) is the WF value, x₄(n+h) is the GWS value, x₅(n+h) is the SC value, x₆(n+h) is the TMP value, x₇(n+h) is the WT value, x₈(n+h) is the PR value, a_{d0}, a_{d1}, a_{d2}, a_{d3}, a_{d4} are the different regression coefficients of the dth characteristic variable. Meanwhile, the dth characteristic variable satisfies

$$\begin{matrix}{Q}_{d} = {\sum }_{n = 1}^{N} {( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) )}^{2} , & ( 2 ) \\ \{ \begin{matrix}\frac{\partial {Q}_{d}}{\partial {a}_{d 0}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) = 0 \\ \frac{\partial {Q}_{d}}{\partial {a}_{d 1}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n ) = 0 \\ ⋮ \\ \frac{\partial {Q}_{d}}{\partial {a}_{d 4}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n + 3 ) = 0\end{matrix} , & ( 3 )\end{matrix}$$

where Q_{d} is the sum of squared errors of the dth characteristic variable with N samples, a_{d0}, a_{d1}, a_{d2}, a_{d3}, a_{d4} are calculated by Eq. (3).

(3) Construct the knowledge base of membrane fouling: The knowledge of membrane fouling, which is extracted from expert experience, can be expressed as the form of fuzzy rules

Rule I: If the WF value is more than 460 m³/h, then the WF value has reached its peak.

Rule II: If the P value is less than 30 LMH/bar and the TMP value is less than −5 kPa, then the membrane is in a state of extreme contamination.

Rule III: If the GWS value is less than 2400 m³/h and the TMP value is less than −20 kPa, then the aeration rate is too low and the membrane is facing serious pollution threat.

Rule IV: If the WF value is less than 300 m³/h and the GWS value is more than 8000 m³/h, then the aeration rate is too high and the membrane silk will be damaged.

Rule V: If the WT value is more than 5 NTU, then the effluent quality has exceeded the standard.

Rule VI: If the P value is more than 90 LMH/bar and the TMP value is less than −40 kPa, then the TMP value is too high and the membrane is facing serious pollution threat.

Rule VII: If the SC value is more than 13000 mg/L, then the SC value is too high and the membrane is facing serious pollution threat.

Rule VIII: If the SC value is less than 6000 mg/L, then the effluent quality has exceeded the standard.

Rule IX: If the P value is less than 80 LMH/bar, the WF value is more than 300 m³/h and the GWS value is less than 4200 m³/h, then the aeration rate is too low and the membrane is facing serious pollution threat.

Rule X: If the WF value is more than 200 m³/h and the WT value is more than 4 NTU, then the effluent quality has exceeded the standard.

Rule XI: If the P value is less than 60 LMH/bar and the TMP value is less than −5 kPa, then the membrane has been seriously polluted.

Rule XII: If the PD value is more than 30 LMH/bar·h, then there is rapid abnormal membrane fouling.

Rule XIII: If the P value is less than 60 LMH/bar, the WF value is more than 200 m³/h and the GWS value is less than 5000 m³/h, then there is a tendency of sludge hardening inside membrane silk.

Rule XIV: If the WF value is less than 300 m³/h, the GWS value is less than 5000 m³/h and the SC value is more than 12000 mg/L, then the operating parameters of membrane tank are unreasonable.

Rule XV: If the WF value is less than 200 m³/h and the PR value is less than 90%, then the online chemical cleaning effect fails to meet the requirements.

Rule XVI: If the P value is more than 80 LMH/bar, the PD value is less than 30 LMH/bar·h, the GWS value is more than 5000 m³/h, the SC value is less than 13000 mg/L, the WT value is less than 4 NTU and the PR value is more than 90%, then there is no warning.

Rule XVII: If the P value is more than 80 LMH/bar, the PD value is less than 30 LMH/bar·h, the GWS value is less than 8000 m³/h, the SC value is less than 13000 mg/L, the WT value is less than 4 NTU and the PR value is more than 90%, then there is no warning.

Rule XVIII: If the P value is more than 80 LMH/bar, the PD value is less than 30 LMH/bar·h, the GWS value is more than 5000 m³/h, the SC value is more than 6000 mg/L, the WT value is less than 4 NTU and the PR value is more than 90%, then there is no warning.

Rule XIX: If the P value is more than 80 LMH/bar, the PD value is less than 30 LMH/bar·h, the GWS value is less than 8000 m³/h, the SC value is more than 6000 mg/L, the WT value is less than 4 NTU and the PR value is more than 90%, then there is no warning.

The above rules of membrane fouling categories can be concluded as

If x₁(n)∈L₁ₖ(n) and . . . x_{d}(n)∈L_{dk}(n) and . . . x₈(n)∈L₈ₖ(n), then yⱼ(n)=rⱼ(n), (4)

where k is the kth fuzzy rule, k=1, 2, . . . , 19, L_{dk}(n) is the linguistic term of the dth characteristic variable in the nth fuzzy rule, yⱼ(n) is the jth membrane fouling category, rⱼ(n) is the linguistic term of the jth membrane fouling category and is formulated as

$${r}_{j} ( n ) = {\sum }_{k = 1}^{19} {v}_{k} ( n ) {w}_{k j} ( n ) , \qquad ( 5 )$$

where wₖⱼ(n) is the weight between the kth fuzzy rule in the rule layer and the jth membrane fouling category in the output layer, vₖ(n) is the output of the rule layer

$$\begin{matrix}{v}_{k} ( n ) = {\prod }_{d = 1}^{8} {L}_{d k} ( n ) / {\sum }_{k = 1}^{19} ( {\prod }_{d = 1}^{8} {L}_{d k} ( n ) ) , & ( 6 ) \\ {L}_{d n} ( n ) = {e}^{- {( {x}_{d} ( n ) - {c}_{d k} ( n ) )}^{2} / 2 {{σ}_{d k} ( n )}^{2}} , & ( 7 )\end{matrix}$$

where c_{dk}(n) and σ_{dk}(n) are the center and width of the dth membership function in the kth fuzzy rule

$$\begin{matrix}{c}_{d k} ( n ) = \frac{{A}_{d k} ( n ) + {B}_{d k} ( n )}{2} , & ( 8 ) \\ {σ}_{d k} ( n ) = max ( \frac{{A}_{d k} ( n ) - {c}_{d k} ( n )}{\sqrt{- 2 ln {L}_{d k} ( n )}} , \frac{{c}_{d k} ( n ) - {B}_{d k} ( n )}{\sqrt{- 2 ln {L}_{d k} ( n )}} ) , & ( 9 )\end{matrix}$$

where A_{dk}(n) and B_{dk}(n) are the upper and lower values of the dth membership function in the kth fuzzy rule.

(4) Establish an intelligent warning model for membrane fouling: The characteristic variables are the input variables of the intelligent warning model. The output variables are selected from the knowledge base of membrane fouling. Then an intelligent warning model based on fuzzy neural network (FNN) is established. The structure of FNN comprises four layers: input layer, membership function layer, rule layer and output layer. The network is 8-19-19-16, including 8 neurons in the input layer, 19 neurons in the membership function layer, 19 neurons in the rule layer and 16 neurons in the output layer. Connection weights between the input layer and the membership function layer are assigned to 1, the input of FNN is X(t)=[x₁(t), x₂(t), . . . , x_{N}(t)], xₙ(t)=[x₁ₙ(t), x₂ₙ(t), . . . , x₈ₙ(t)], t=1, 2, . . . , T, T is the number of iterations. The expectation output of neural network is expressed as Yₑ(t) and the actual output is expressed as Y(t). The four layers of FNN are described in detail as follows:

The Input Layer:

There are 8 neurons which represent the input variables in this layer. The output value of each neuron is

uᵢ(t)=xᵢ(t),i=1,2, . . . ,8, (10)

where uᵢ(t) is the ith output vector at the tth iteration and the input vector is xᵢ(t)=[x₁(t), x₂(t), . . . , x_{N}(t)].

The Membership Function Layer:

There are 19 neurons of the membership function layer. The outputs of the membership function neurons are

$${φ}_{k} ( t ) = {\prod }_{d = 1}^{8} {e}^{- {( {u}_{d} ( t ) - {c}_{d k} ( t ) )}^{2} / 2 {{σ}_{d k} ( t )}^{2}} , \qquad ( 11 )$$

where c_{dk}(t) denotes the center vector of the kth membership function neuron at the tth iteration, c_{dk}(t)=[c_{dk1}(t), c_{dk2}(t), . . . , c_{dkN}(t)]^{T}, and σ_{dk}(t) is the width vector of the kth membership function neuron at the tth iteration, σ_{dk}(t)=[σ_{dk1}(t), σ_{dk2}(t), . . . , σ_{dkN}(t)] ^{T}.

The Rule Layer:

There are 19 neurons of the rule layer. The outputs are

$${v}_{k} ( t ) = {φ}_{k} ( t ) / {\sum }_{k = 1}^{19} {φ}_{k} ( t ) , \qquad ( 12 )$$

where vₖ(t) is the output vector of the kth rule neuron at the tth iteration, vₖ(t)=[vₖ₁(t), vₖ₂(t), . . . , v_{kN}(t)]^{T}.

The Output Layer:

This layer contains 16 neurons. The output values are

$${Y}_{j} ( t ) = {\sum }_{k = 1}^{19} {v}_{k} ( t ) {w}_{kj} ( t ) , j = 1 , 2 , … , 16 , \qquad ( 13 )$$

where Yⱼ(t)=[y₁(t), y₂(t), . . . , y_{N}(t)], which is the membrane fouling category, represents the output of FNN at the tth iteration, wₖⱼ(t)=[wₖⱼ₁(t), wₖⱼ₂(t), . . . , w_{kjN}(t)]^{T} is the connection weight between the kth rule neuron and the jth output neuron at the tth iteration. Based on the softmax function, the probabilities of the output neurons are

$${p}_{j} ( t ) = \frac{{e}^{{Y}_{j} ( t )}}{{\sum }_{j = 1}^{16} {e}^{{Y}_{j} ( t )}} , \qquad ( 14 )$$

where pⱼ(t) is the probability vector of the jth output neuron at the tth iteration, pⱼ(t)=[pⱼ₁(t), pⱼ₂(t), . . . , p_{jN}(t)]^{T}, the jth membrane fouling category with the corresponding maximum value of pⱼ(t) is selected to warn the future events of membrane fouling.

(5) Train the FNN model:

\textcircled{1} Given the FNN model, the inputs of FNN are x(1), x(2), . . . , x(t), . . . , x(T), correspondingly, the expectation outputs are Y_{d}(1), Y_{d}(2), . . . , Y_{d}(t), . . . , Y_{d}(T).

\textcircled{2} Set the learning step s=1.

\textcircled{3} t=s; According to Eqs. (1)-(14), calculate the probabilities of the output neurons, exploiting gradient descent algorithm

$${w}_{kj} ( t + 1 ) = {w}_{kj} ( t ) + {η}_{w} \frac{1}{16} {\sum }_{j = 1}^{16} \{ {v}_{k} ( t ) [ I ( t ) - {p}_{j} ( t ) ] \} , \qquad ( 15 )$$

where wₖⱼ(t+1) is the connection weight between the kth rule neuron and the jth output neuron at the t+1th iteration, η_{w}∈(0, 0.01] is the learning rate, I(t)=[1{Y₁(t)}, 1{Y₂(t)}, . . . , 1{Y₁₆(t)}], 1{⋅} represents the indicator function.

\textcircled{4} If t≤T, go to step \textcircled{3}; if t>T, stop the training process.

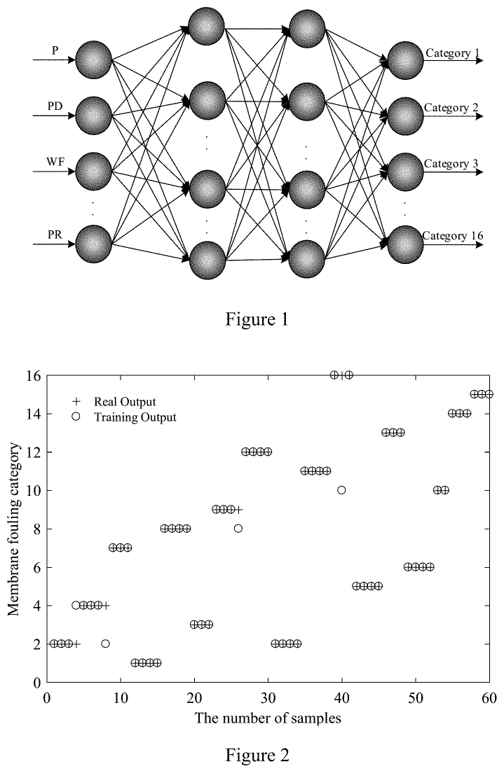

The training result of the intelligent warning method for membrane fouling is shown in FIG. 2. X axis shows the number of samples. Y axis shows the membrane fouling category. The red cross presents the real categories of membrane fouling. The bule circle shows the outputs of intelligent warning method in the training process.

(6) Realize membrane fouling warning:

The least-squares linear regression model utilizes the testing samples of P, PD, WF, GWS, SC, TMP, WT and PR to predict multiple values of these characteristic variables. Then, the testing samples of P, PD, WF, GWS, SC, TMP, WT and PR are used as the inputs of FNN, the outputs of FNN are the membrane fouling categories.

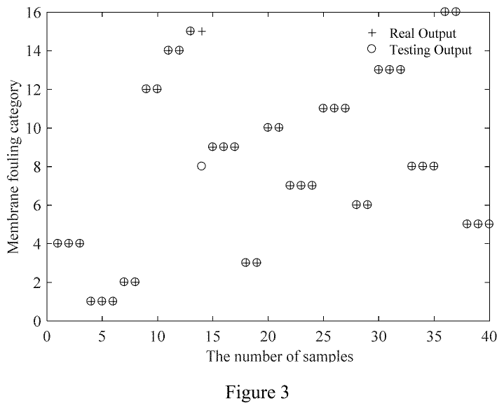

The testing result is shown in FIG. 3. X axis shows the number of testing samples. Y axis shows the membrane fouling category. The red cross presents the real values of membrane fouling category. The bule circle shows the outputs of intelligent warning method in the testing process.

What is claimed is:

1. A membrane fouling warning method based on knowledge-fuzzy learning algorithm comprising:
(1) determine characteristic variables of membrane fouling: for a sewage treatment process of membrane bioreactor, sewage treatment process variables are analyzed and the characteristic variables of membrane fouling are selected, including water permeability (P), permeability decay (PD), water flow (WF), gas washing size (GWS), sludge concentration (SC), transmembrane pressure (TMP), water turbidity (WT) and permeability recovery rate (PR);
(2) predict the characteristic variables of membrane fouling: the characteristic variables are obtained by a multi-step prediction strategy based on a least-squares linear regression model; values of a characteristic variable with first four moments are used to predict the characteristic variable at a fifth moment; the estimation of a characteristic variable using the least-squares linear regression model can be expressed as:
x_{d}(n+4)=a_{d0}+a_{d1}x_{d}(n)+a_{d2}x_{d}(n+1)+a_{d3}x_{d}(n+2)+a_{d4}x_{d}(n+3), (1)
where x_{d}(n+h) is dth characteristic variable value, n=1, 2, . . . , N−4, Nis the number of samples, d=1, 2, . . . , 8, h=0, 1, . . . , 4, x₁(n+h) is a P value, x₂(n+h) is a PD value, x₃(n+h) is a WF value, x₄(n+h) is a GWS value, x₅(n+h) is a SC value, x₆(n+h) is a TMP value, x₇(n+h) is a WT value, x₈(n+h) is a PR value, a_{d0}, a_{d1}, a_{d2}, a_{d3}, a_{d4} are different regression coefficients of the dth characteristic variable, and the dth characteristic variable satisfies:
$$\begin{matrix}{Q}_{d} = {\sum }_{n = 1}^{N} {( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) )}^{2} , & ( 2 ) \\ \{ \begin{matrix}\frac{\partial {Q}_{d}}{\partial {a}_{d 0}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) = 0 \\ \frac{\partial {Q}_{d}}{\partial {a}_{d 1}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n ) = 0 \\ ⋮ \\ \frac{\partial {Q}_{d}}{\partial {a}_{d 4}} = - 2 {\sum }_{n = 1}^{N} ( {x}_{d} ( n + 4 ) - {a}_{d 0} - {a}_{d 1} {x}_{d} ( n ) - {a}_{d 2} {x}_{d} ( n + 1 ) - {a}_{d 3} {x}_{d} ( n + 2 ) - {a}_{d 4} {x}_{d} ( n + 3 ) ) {x}_{d} ( n + 3 ) = 0\end{matrix} , & ( 3 )\end{matrix}$$
where Q_{d} is the sum of squared errors of the dth characteristic variable with N samples, a_{d0}, a_{d1}, a_{d2}, a_{d3}, a_{d4} are calculated by Eq. (3);
(3) construct a knowledge base of membrane fouling: a knowledge of membrane fouling, which is extracted from expert experience, can be expressed as the form of fuzzy rules:
Rule I: if the WF value is more than 460 m³/h, then the WF value has reached its peak;
Rule II: if the P value is less than 30 LMH/bar and the TMP value is less than −5 kPa, then membrane is in a state of extreme contamination;
Rule III: if the GWS value is less than 2400 m³/h and the TMP value is less than −20 kPa, then an aeration rate is too low and the membrane is facing serious pollution threat;
Rule IV: if the WF value is less than 300 m³/h and the GWS value is more than 8000 m³/h, then the aeration rate is too high and membrane silk will be damaged;
Rule V: if the WT value is more than 5 NTU, then effluent quality has exceeded a standard;
Rule VI: if the P value is more than 90 LMH/bar and the TMP value is less than −40 kPa, then the TMP value is too high and the membrane is facing serious pollution threat;
Rule VII: if the SC value is more than 13000 mg/L, then the SC value is too high and the membrane is facing serious pollution threat;
Rule VIII: if the SC value is less than 6000 mg/L, then the effluent quality has exceeded the standard;
Rule IX: if the P value is less than 80 LMH/bar, the WF value is more than 300 m³/h and the GWS value is less than 4200 m³/h, then the aeration rate is too low and the membrane is facing serious pollution threat;
Rule X: if the WF value is more than 200 m³/h and the WT value is more than 4 NTU, then the effluent quality has exceeded the standard;
Rule XI: if the P value is less than 60 LMH/bar and the TMP value is less than −5 kPa, then the membrane has been seriously polluted;
Rule XII: if the PD value is more than 30 LMH/bar·h, then there is rapid abnormal membrane fouling;
Rule XIII: if the P value is less than 60 LMH/bar, the WF value is more than 200 m³/h and the GWS value is less than 5000 m³/h, then there is a tendency of sludge hardening inside the membrane silk;
Rule XIV: if the WF value is less than 300 m³/h, the GWS value is less than 5000 m³/h and the SC value is more than 12000 mg/L, then operating parameters of membrane tank are unreasonable;
Rule XV: if the WF value is less than 200 m³/h and the PR value is less than 90%, then online chemical cleaning effect fails to meet requirements;
Rule XVI: if the P value is more than 80 LMH/bar, the PD value is less than 30 LMH/bar·h, the GWS value is more than 5000 m³/h, the SC value is less than 13000 mg/L, the WT value is less than 4 NTU and the PR value is more than 90%, then there is no warning;
Rule XVII: if the P value is more than 80 LMH/bar, the PD value is less than 30 LMH/bar·h, the GWS value is less than 8000 m³/h, the SC value is less than 13000 mg/L, the WT value is less than 4 NTU and the PR value is more than 90%, then there is no warning;
Rule XVIII: if the P value is more than 80 LMH/bar, the PD value is less than 30 LMH/bar·h, the GWS value is more than 5000 m³/h, the SC value is more than 6000 mg/L, the WT value is less than 4 NTU and the PR value is more than 90%, then there is no warning;
Rule XIX: if the P value is more than 80 LMH/bar, the PD value is less than 30 LMH/bar·h, the GWS value is less than 8000 m³/h, the SC value is more than 6000 mg/L, the WT value is less than 4 NTU and the PR value is more than 90%, then there is no warning;
the above fuzzy rules of membrane fouling categories can be concluded as
if x₁(n)∈L₁ₖ(n) and . . . x_{d}(n)∈L_{dk}(n) and . . . x₈(n)∈L₈ₖ(n), then yⱼ(n)=rⱼ(n), (4)
where k is kth fuzzy rule, k=1, 2, . . . , 19, L_{dk}(n) is a linguistic term of the dth characteristic variable in nth fuzzy rule, yⱼ(n) is jth membrane fouling category, rⱼ(n) is a linguistic term of the jth membrane fouling category and is formulated as:
$${r}_{j} ( n ) = {\sum }_{k = 1}^{19} {v}_{k} ( n ) {w}_{kj} ( n ) , \qquad ( 5 )$$
where wₖⱼ(n) is a weight between the kth fuzzy rule in a rule layer and the jth membrane fouling category in an output layer, vₖ(n) is an output of the rule layer:
$$\begin{matrix}{v}_{k} ( n ) = {\prod }_{d = 1}^{8} {L}_{dk} ( n ) / {\sum }_{k = 1}^{19} ( {\prod }_{d = 1}^{8} {L}_{dk} ( n ) ) , & ( 6 ) \\ {L}_{dn} ( n ) = {e}^{- {( {x}_{d} ( n ) - {c}_{dk} ( n ) )}^{2} / 2 {{σ}_{dk} ( n )}^{2}} , & ( 7 )\end{matrix}$$
where c_{dk}(n) and σ_{dk}(n) are a center and a width of dth membership function in the kth fuzzy rule:
$$\begin{matrix}{c}_{d k} ( n ) = \frac{{A}_{d k} ( n ) + {B}_{d k} ( n )}{2} , & ( 8 ) \\ {σ}_{d k} ( n ) = max ( \frac{{A}_{d k} ( n ) - {c}_{d k} ( n )}{\sqrt{- 2 ln {L}_{d k} ( n )}} , \frac{{c}_{d k} ( n ) - {B}_{d k} ( n )}{\sqrt{- 2 ln {L}_{d k} ( n )}} ) , & ( 9 )\end{matrix}$$
where A_{dk}(n) and B_{dk}(n) are upper and lower values of the dth membership function in the kth fuzzy rule;
(4) establish an intelligent warning model for membrane fouling: the characteristic variables are input variables of the intelligent warning model; output variables are selected from the knowledge base of membrane fouling; then an intelligent warning model based on fuzzy neural network (FNN) is established; a structure of FNN comprises four layers: an input layer, a membership function layer, a rule layer and an output layer; a network is 8-19-19-16, including 8 neurons in the input layer, 19 neurons in the membership function layer, 19 neurons in the rule layer and 16 neurons in the output layer; connection weights between the input layer and the membership function layer are assigned to 1; an input of FNN is X(t)=[x₁(t), x₂(t), . . . , x_{N}(t)], xₙ(t)=[x₁ₙ(t), x₂ₙ(t), . . . , x₈ₙ(t)], t=1, 2, . . . , T, T is the number of iterations; an expectation output of neural network is expressed as Yₑ(t) and an actual output is expressed as Y(t); four layers of FNN are specifically as follows:
the input layer: there are 8 neurons which represent input variables in this layer, an output value of each neuron is
uᵢ(t)=xᵢ(t),i=1,2, . . . ,8, (10)
where uᵢ(t) is ith output vector at tth iteration and an input vector is xᵢ(t)=[x₁(t), x₂(t), . . . , x_{N}(t)];
the membership function layer: there are 19 neurons of the membership function layer; outputs of the membership function neurons are:
$${φ}_{k} ( t ) = {\prod }_{d = 1}^{8} {e}^{- {( {u}_{d} ( t ) - {c}_{d k} ( t ) )}^{2} / 2 {{σ}_{d k} ( t )}^{2}} , \qquad ( 11 )$$
where c_{dk}(t) denotes a center vector of kth membership function neuron at the tth iteration, c_{dk}(t)=[c_{dk1}(t), c_{dk2}(t), . . . , c_{dkN}(t)]^{T}, and σ_{dk}(t) is a width vector of the kth membership function neuron at the tth iteration, σ_{dk}(t)=[σ_{dk1}(t), σ_{dk2}(t), . . . , σ_{dkN}(t)]^{T},
the rule layer: there are 19 neurons of the rule layer; outputs of the rule layer are:
$${v}_{k} ( t ) = {φ}_{k} ( t ) / {\sum }_{k = 1}^{19} {φ}_{k} ( t ) , \qquad ( 12 )$$
where vₖ(t) is an output vector of kth rule neuron at the tth iteration, vₖ(t)=[vₖ₁(t), vₖ₂(t), . . . , v_{kN}(t)]^{T};
the output layer: this layer contains 16 neurons; output values of the output layer are:
$${Y}_{j} ( t ) = {\sum }_{k = 1}^{19} {v}_{k} ( t ) {w}_{kj} ( t ) , j = 1 , 2 , … , 16 , \qquad ( 13 )$$
where Yⱼ(t)=[y₁(t), y₂(t), . . . , y_{N}(t)], which is the membrane fouling category, represents the output of FNN at the tth iteration, wₖⱼ(t)=[wₖⱼ₁(t), wₖⱼ₂(t), . . . , w_{kjN}(t)]^{T} is a connection weight between the kth rule neuron and the jth output neuron at the tth iteration; based on a softmax function, probabilities of the output neurons are:
$${p}_{j} ( t ) = \frac{{e}^{{Y}_{j} ( t )}}{{\sum }_{j = 1}^{16} {e}^{{Y}_{j} ( t )}} , \qquad ( 14 )$$
where pⱼ(t) is a probability vector of the jth output neuron at the tth iteration, pⱼ(t)=[pⱼ₁(t), pⱼ₂(t), . . . , p_{jN}(t)]^{T}, the jth membrane fouling category with a corresponding maximum value of pⱼ(t) is selected to warn future events of membrane fouling;
(5) train the FNN model:
\textcircled{1} given the FNN model, inputs of FNN are x(1), x(2), . . . , x(t), . . . , x(T), correspondingly, expectation outputs are Y_{d}(1) Y_{d}(2), . . . , Y_{d}(t), . . . , Y_{d}(T);
\textcircled{2} set learning step s=1;
\textcircled{3} t=s; according to Eqs. (1)-(14), calculate probabilities of the output neurons, exploiting gradient descent algorithm:
$${w}_{kj} ( t + 1 ) = {w}_{kj} ( t ) + {η}_{w} \frac{1}{16} {\sum }_{j = 1}^{16} \{ {v}_{k} ( t ) [ I ( t ) - {p}_{j} ( t ) ] \} , \qquad ( 15 )$$
where wₖⱼ(t+1) is a connection weight between the kth rule neuron and the jth output neuron at t+1th iteration, η_{w}∈(0, 0.01] is a learning rate, I(t)=[1{Y₁(t)}, 1{Y₂(t)}, . . . , 1{Y₁₆(t)}], 1{⋅} represents an indicator function;
\textcircled{4} if t≤T, go to step \textcircled{3}; if t>T, stop the training process;
(6) realize membrane fouling warning:
the least-squares linear regression model utilizes testing samples of P, PD, WF, GWS, SC, TMP, WT and PR to predict multiple values of the characteristic variables; then, the testing samples of P, PD, WF, GWS, SC, TMP, WT and PR are used as the inputs of FNN, the outputs of FNN are the membrane fouling categories.
